(19) United States
(12) Patent Application Publication
(10) Pub. No.: US 2008/0094158 A1
(43) Pub. Date: Apr. 24, 2008

(54) Locking device

(75) Inventor: Max Schmid, Wangs (CH)

Correspondence Address: BUCHANAN, INGERSOLL & ROONEY PC, POST OFFICE BOX 1404, ALEXANDRIA, VA, 22313-1404, US

(73) Assignee: Elesta relays GmbH, Bad Ragaz (CH)

(21) Appl. No.: 11/976,189

(22) Filed: Oct. 22, 2007

(30) Foreign Application Priority Data
Oct. 23, 2006 (CH) 01677/06

(51) Int. Cl. H01F 7/08

(52) U.S. Cl. 335/291

(57) ABSTRACT

The disclosure relates to a locking system with an electromagnet and a yoke plate that closes the magnetic circuit of the electromagnet. In the latter, the electromagnet is fastened with a fastening element to pivot around a point on a central axis and is tightly fastened in the longitudinal direction of the central axis. Said central axis runs perpendicular to the contact plane between the electromagnet and the yoke plate and through the center of the holding force of the closed electromagnet. As a result, a force that acts against the magnetic force to detach the yoke plate from the pole surface always acts coaxially with the magnetic force, thus keeping the yoke plate from being detached from the pole surface on one side.

### RELATED APPLICATIONS

This application claims priority under 35 U.S.C. §119 to Swiss Patent Application No. 01677/06 filed in Switzerland on Oct. 23, 2006, the entire contents of which are hereby incorporated by reference in their entireties.

### TECHNICAL FIELD

A magnetic safety locking device is disclosed with an electromagnet and a yoke plate that works together with the electromagnet.

### BACKGROUND INFORMATION

A screw-on magnetic door fastener, in which a cylindrical permanent magnet with two pole flanges that are curved in the shape of a barrel is housed in a first component, is known from the German Utility Model No. 231837. The pole flanges interact with a round, movable holding plate. To allow the exact adjustment of the holding plate on the two pole flanges of the permanent magnet, the hole in the holding plate is kept somewhat larger than the diameter of the shank of the fastening screw and is provided with a corresponding countersink. When the holding plate is screwed onto the furniture door, a washer that is made of plastic that is as flexible as possible is placed underneath it. This ensures that the round holding plate can always tilt to the extent that it rests exactly on the two pole flanges because of the plastic base. Only thus is a perfect short-circuit of the magnet achieved.

A locking system in which an electric pot-shaped magnet and a read head assembly are installed beside one another in a first component is known from EP 1 430 497. This first component is provided for a secure mounting on a preferably immovable edge of an opening that is to be closed with a movable closing part. The second component consists of a counter-element and a base element, whereby the counter-element is fastened to the basic element so as to be unable to move in the actuation direction, while it is to be able to rotate relative to at least two axes perpendicular to the actuation direction. The rotatability, as is common in cabinet door magnetic locks, is used for precise orientation of the support surface of the counterpart to the support surface of the magnet, so that a perfect short-circuit of the magnetic circuit is achieved.

It has been shown that the holding force of the magnet is dependent on the magnet and yoke being aligned perfectly facing one another. This precision of said alignment wherein the magnet and yoke face one another is dependent upon a specific assembly. It is also dependent, however, on a change in position of the closing part compared to the closable opening because of, for example, widening action or aging.

An electromagnetic closing device, in which an electromagnet is screwed to a counter-plate, and said counter-plate is fastened in a door frame profile, is known from FR-A-2 654 143. A hole that has a section with a smaller diameter on the back side and a section with a larger diameter on the pole side is present axially in the magnet. The screw sits in this hole. On the base of the section with the larger diameter, the head of said screw presses against the edge of the hole with the smaller diameter, and the threaded end thereof is screwed into the counter-plate. A rubber ring, which allows a slight pivoting of the electromagnet relative to the counter-plate, is located between the counter-plate and the electromagnet. As a result, the electromagnet and the yoke plate that is fastened to the door rest on one another over the entire surface when the door is closed. In this fastening of the magnet, its pivotability around a pivot point that lies on the central axis, which moreover, is relatively close to the pole surface of the magnet, is advantageous. As a result, when matching the inclination of the pole side, only slight movements of the magnet are produced. The attenuation of the magnet by the hole that hinders the magnetic flux is disadvantageous in this prior art.

### SUMMARY

An object of the disclosure to provide a safety-locking device, in which a maximum holding force of the magnet is achieved, is derived from this prior art. In this case, relative to the accuracy of the alignment of the two interacting parts, the device is to allow relatively high tolerances. The holding force is therefore also to be maintained if the closing element begins to dangle somewhat or has been violently forced out of its original position. In particular, in addition to securing a perfect magnetic short-circuit, the holding force of the magnet is to be optimized if a force is exerted against the holding force of the magnet on the device in an opening test of a closing part that is closed with a locking device. This holding force is also to be optimal when the alignment of the magnet and the yoke to face one another is not—or is no longer—optimal.

The locking device comprises an electromagnet and a yoke plate that closes the magnetic circuit of the electromagnet. According to the disclosure, the electromagnet is fastened with a fastening element to pivot around a point on a central axis and is fastened tightly in the longitudinal direction of the central axis. In this case, the central axis runs perpendicular to the contact plane between the electromagnet and the yoke plate and, moreover, through the center of the holding force of the closed electromagnet.

It has been shown that the holding force of a magnet is subjected to great fluctuations, depending on how centrically or how eccentrically the magnet is removed from the yoke plate. Accordingly, if the yoke plate, as proposed in the prior art, is connected tightly to a base, e.g., a bottom or a base plate, to move around a point on the central axis of the yoke plate, this condition is often not met. If namely the central axis of the yoke plate does not run through the center of force of the electromagnetic field, the magnetic force is not introduced centrically into the yoke plate. If a force that acts in opening direction from the outside is now introduced into this connection between the magnet and the yoke plate, the yoke plate tilts, since the force acts eccentrically on the yoke plate. In the case of a pot-shaped magnet with an approximately 5 cm diameter that is suitable for locking devices, a test was performed. The holding force was measured in the case of full-face and centric introduction of the force and in the case of a full-face and approximately 5 mm eccentric introduction of the force. In this case, a reduction in holding force by 35% had to be determined.

Because the electromagnet is centric and articulated according to the disclosure, however, the magnetic force always acts on the same axis as the force that counteracts the magnetic force, which attempts to detach the magnet from the yoke plate. As a result, optimal holding forces are also achieved even if the yoke plate is not optimally oriented relative to the magnet. Preferably, the contact surface of the yoke plate is somewhat larger than the pole surface of the electromagnet, such that this pole surface also rests full-face on the yoke plate even if it is slightly offset. The yoke plate is tightly and immovably fastened to the bottom or to a base plate. Relative to this base, it can also be pivotable in a small mass such that yielding of the yoke plate by tipping can be compensated by the mobility of the magnet. It can also be tippable only by adjusting the yoke plate and electromagnet and can be connected tightly to the base after the adjustment.

For a pivotable and central connection of the electromagnet, the fastening element comprises a central pin that is fastened in a non-pivoting manner to the electromagnet and that for its part is mounted to pivot on a base, i.e., a bottom or a base plate. The shaft of the pin coincides with the central axis of the electromagnet. Thanks to an elastic mounting arrangement, the electromagnet in each case is moved into the optimal position when pulling is exerted on it in the direction of the pin or the central axis. The pin that is anchored in the electromagnet in such a way that it cannot pivot does not interrupt the magnetic flux in the electromagnet, such that the provision of the pin does not produce any attenuation of the magnet. Therefore, the magnet may have relatively small dimensions in comparison to the holding force that is achieved.

For an elastic connection of the magnet, the pin is run through a hole in the base, in particular a base plate. On the side of the base—in particular the base plate—that faces away from the magnet, an elastic intermediate layer is present between a top formation on the pin and the base. So that the sought-after freedom of motion is present, the diameter of the hole must be larger than the diameter of the pin. An elastic intermediate layer, especially preferably a rubber coupling, which forms two elastic intermediate layers, is also suitably between the pin and the hole. So that the magnet is also supported against the base plate, this coupling or a separate part forms an elastic intermediate layer between the magnet and the base, e.g., the base plate.

Metal spring elements can also be used as elastic intermediate layers.

The base can be part of the locking device, i.e., a base plate, or part of a machine or a danger area in which the device is to be used, i.e., a background.

In a way that is known in the art, suitably at least one monitoring element for monitoring the closed state of the locking device is present in the locking device.

If an electromechanical or electronic component that reacts on a magnetic field is present adjacent to the electromagnet or within the electromagnet, the closed state of the magnetic circuit can be monitored. It can therefore be determined whether the yoke plate abuts it or not. This component produces the desired signal only if the yoke plate abuts it and thus closes the magnetic circuit and if the electromagnet is activated, and therefore a locking force is actually also effective. If the yoke does not abut it or the magnet is not activated, the action of the magnetic circuit on this element is significantly lower, and this therefore provides a distinguishably different signal. In the case of a reed switch, the contact is closed or interrupted, and in the case of a Hall sensor, its signal is very different.

Suitably, the electromagnet and the yoke plate are not to be fastened directly to a base. If namely a first component is formed from a first base plate, which carries the electromagnet, and a second component is formed from a second base plate, which carries the yoke plate, these components can be designed specifically for a fastening to a base. The fastening of the electromagnet and also the yoke plate relative to these base plates can be controlled at the plant. Moreover, additional components can be fastened in these base plates or on these base plates.

Namely the first base plate can be fastened to pivot around a point on the central axis, and it can be fastened tightly to a base in the longitudinal direction of the central axis. It is preferred, however, if the electromagnet is fastened to pivot around the point on the central axis and is fastened tightly to the first base plate in longitudinal direction of the central axis.

The same holds true for the yoke side. The pivotability of the yoke plate, however, has lesser importance. It must not be possible for the yoke plate to pivot around a point on the central axis of the yoke plate. The yoke plate is rather to be mounted in as unyielding a manner as possible in the mounted state. Its pivotability is rather to serve as an initial adjustment to the orientation thereof.

Suitably, one of the two components is equipped with a permanent magnet, and the other component is equipped with an electromechanical or electronic element, and said element reacts to the magnetic field of the permanent magnet. The first or second base plate with the permanent magnet is preferred, and the other base plate is equipped with the element that reacts to the magnetic field of the permanent magnet. Such an element is preferably a reed contact, but can also be a Hall sensor or the like.

Moreover, the first and second components—preferably the first and the second base plates—each advantageously have one of two electronic transmitting/receiving devices that work together in a non-contact manner. The latter can communicate with one another in code. Therefore, by the provision of these devices on or in the two components, an increased handling safety is achieved. Such a transmitting/receiving device can be an RFID based on transponder technology, two communicating infrared transmitting/receiving units, or the like.

The locking device is configured in a preferred embodiment such that the influence of the magnetic field of the permanent magnet on the electromechanical or electronic element, which reacts to the magnetic field of the permanent magnet, has the effect that the electromagnet is activated. However, it is advantageous to use the interaction between the transmitting/receiving devices to detect the approaching component. It is also possible, however, to configure the influences of the permanent magnet and the transmitting/receiving device differently.

A safety switch, with which it is monitored whether the signal of the transmitting/receiving device is present, on the one hand, and the signal of the electromechanical or electronic element that reacts to the magnetic flux in the electromagnet and is adjacent to the electromagnet or within the electromagnet is present, on the other hand, is suitably present. If both signals are present, the magnetic circuit is closed by the correct yoke plate, and the electromagnet attracts fairly strongly. This information is specifically that information that ensures that safety is maintained, that the danger area is secured, and that the safety locking device has not been manipulated.

The additional information of the reed contact, for example, which reacts to the permanent magnet, can only be used in that the electromagnet is activated only if the yoke plate abuts the pole surface. It also then forms, however, a chain link in the safety monitoring. If namely one foreign pole flange abuts it, it can be assumed that no permanent magnet is present at the correct position to be able also to activate the electromagnet.

The electromagnet is advantageously a pot-shaped magnet. The latter has a central core, which forms a central pole. It also has a ring that is connected to this central core at the bottom of the pot and forms a peripheral pole. Its winding is formed between this core and this ring. The electromagnet is characterized in that the diameter of the central pole on its pole side is larger than the diameter of the core in the area of the winding. In other words, the core is designed in the form of a spool of thread and thus has one ring-shaped flange in front of the winding and another behind it. These flanges form the bottom of the pot, on the one hand, and the central pole on the pole surface, on the other hand. The flange in the area of the bottom of the pot has a larger diameter than the flange in the area of the pole surface. The ring is formed by a pipe that is tightly attached to the flange that forms the bottom. The flanges can be mounted as rings on a cylindrical core. The core that is shaped like a spool of thread can also be formed, in particular turned, from a whole piece.

### BRIEF DESCRIPTION OF THE DRAWINGS

The figures show an exemplary embodiment of the disclosure.

FIG. 1 shows a diagrammatic cross-section through a mounted locking device according to the disclosure in the closed state.

FIG. 2 shows a diagrammatic cross-section through the locking device in the open state.

FIG. 3 shows a diagrammatic cross-section through a locking device with two electromagnets.

FIG. 4 shows a diagrammatic view of the two components of the locking device.

FIG. 5 shows a diagrammatic cross-section through an alternative design of the locking device.

### DETAILED DESCRIPTION

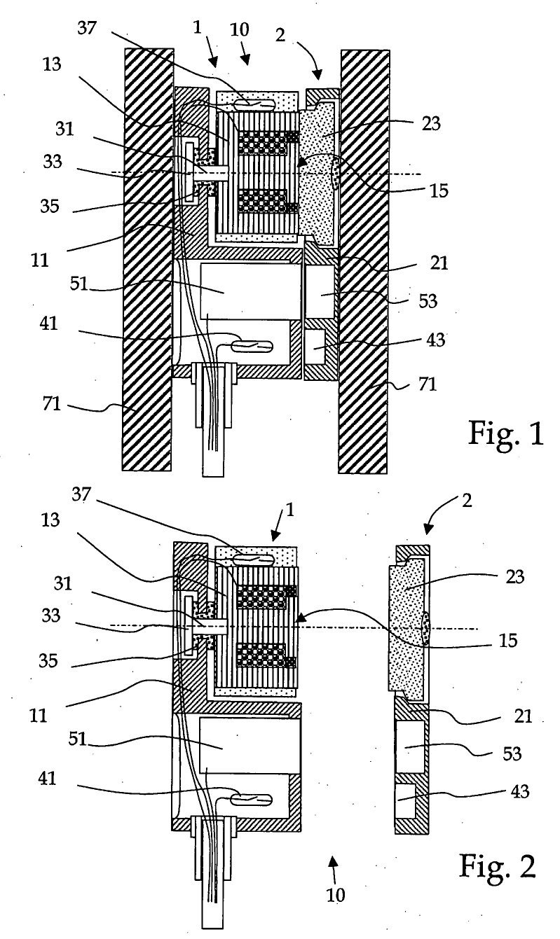

The exemplary device 10 that is shown mounted on a base 71 in FIG. 1 and detached from the base in FIG. 2 comprises a first component 1 and a second component 2. The first component 1 is essentially formed from a first base plate 11 and an electromagnet 13 that is fastened thereto. The second component 2 is essentially formed from a second base plate 21 and a yoke plate 23 that is fastened thereto. The first and the second components 1, 2 are tightly and immovably mounted on the base 71. The first component 1 is fastened to a solid base 71, in which a closable opening is present. The second component 2 is fastened to a closing part to close this opening. When opening the opening, the bases 71 of the two components are removed from one another and thus lift the components from one another. In FIG. 2, the components 1, 2 are shown in positions that are removed from one another.

The electromagnet 13 is fastened tightly but movably to the first base plate 11. The mobility is limited to a pivotability of the electromagnets in all directions around axes that are parallel to its pole surface 15.

This mobility is achieved by the mounting of the electromagnet on the base plate 11. A pin 31 is fastened to the electromagnet 13. The pin 31 extends through a hole in the base plate 11. A top 33 is formed on the pin behind the hole. This top can be formed by, e.g., a nut or a screw head. An elastic intermediate layer 35 in the form of a rubber part is present between the base plate 11 and the fastening means (pins 31, top formation 33) for the electromagnet 3. Instead of the rubber part, two coil springs or spring washers can also be provided that elastically fill the space between the electromagnet and the base plate 11, as between the top formation 33 and the base plate 11. Thus, a pivotable fastening of the electromagnet to the base plate and thus to the base is achieved. Because the intermediate layer 35 is designed like a spring, the electromagnet 13 is present in each case in a basic orientation. In a merging with the yoke plate 23, however, the electromagnet 13 is oriented exactly parallel to the yoke plate 23 and abuts it full-face. Minor differences in the orientation of the two components with respect to one another are thus detected.

The fastening of the electromagnet via a central pin is therefore important, since when the yoke plate 23 is removed from the activated electromagnet (13), this fastening ensures that the forces between the yoke and the electromagnet always coincide with an axis that runs perpendicular to the contact plane and through the fastening point. As a result, it is ensured that the forces always occur perpendicular to the contact plane and pole surface and no tilting moment can act on the electromagnet 13 and the yoke plate 23. As a result, the holding forces between the electromagnet and the yoke are optimized.

It is essential to the disclosure that the pivot point, around which the electromagnet can pivot, is on an axis that is perpendicular and, relative to the magnetic forces, centric through the pole surface. The site of the magnetic force is determined by the electromagnet, not by the yoke plate. Therefore, the yoke plate is connected as tightly as possible to the base and the component 21 that carries the yoke plate. It can, however, still be fastened in an easily pivotable manner. It can be present as, e.g., an insert in the component 21. The pivotability of the yoke plate must be narrowly confined such that the electromagnet can take part in the tilting motion of the yoke plate, and therefore non-eccentric forces are produced. It is advantageously to serve only the initial or sporadic adjustment of the orientation.

In the first base plate 11 that carries the electromagnet and in the electromagnet 13, electric and electronic components that are used for the safety of the operation of the locking device are integrated. The latter are:
1. A reed contact 37 that is arranged adjacent to the electromagnet 13. The latter is activated as soon as the electromagnet exerts a sufficient force on the magnetic disk, i.e., it reacts to the magnetic flux in the electromagnet. This reed contact is activated only if the electromagnet is under sufficient current and the yoke plate tightly abuts it. Otherwise, the magnetic flux in the electromagnet is too small to activate the reed contact. A foreign part that is manipulatively arranged as a yoke plate must have a minimum thickness of, for example, 4 to 6 mm, so that the magnetic flux achieves a sufficient mass to actuate the reed contact.
2. A reed contact 41 that is arranged in the first component 11 and a permanent magnet 43 that is arranged in the second component 21. This reed contact 41 is activated by the magnetic field of the permanent magnet 43. It can thus be monitored whether the locking device is in closed position.
3. An RFID transmitting/receiving element 51, which is located in the first component 1, and a transponder 53, which is located in the second component 2. The latter are used in the manipulation safety of the locking device. They must not primarily monitor the relative position of the two interacting elements of the device but rather only the affiliation of the yoke plate to the magnet. They hinder manipulation by short-circuiting the electromagnet by means of a foreign iron part of sufficient thickness, when their range is less than the removal of the two transmitting/receiving elements in the case of a manipulative arrangement of a foreign iron plate between the yoke plate and the pole surface.
With these safety components, manipulation of the device is ruled out to a large extent, because:
If the RFID elements 51, 53 do not detect each other, it is thus possible to keep activation of the danger area from taking place. If they do detect one another, it is virtually ensured that the attracted yoke plate is the correct one.
If the correct yoke plate is not removed correctly from the electromagnet, the reed contact 37 does not activate. This can stem from the electromagnet receiving too little flux or no flux or the yoke plate not abutting it. If, however, the reed contact is activated, the yoke plate abuts it, and the electromagnet is supplied with sufficient power.
The permanent magnet is used primarily for activating the electromagnet. It is to be ensured that the electromagnet is activated only if the yoke plate tightly abuts it or at least almost abuts it. This keeps the yoke plate from hitting the pole surface at high speed. Moreover, additional safety in the chain of safety measures is achieved with this permanent magnet and the element that reacts to the permanent magnet. If no permanent magnet is present, or the distance between the permanent magnet and the element that reacts to the latter is too large, it can be ruled out that the opening, as with the closing part, is found to be closed.

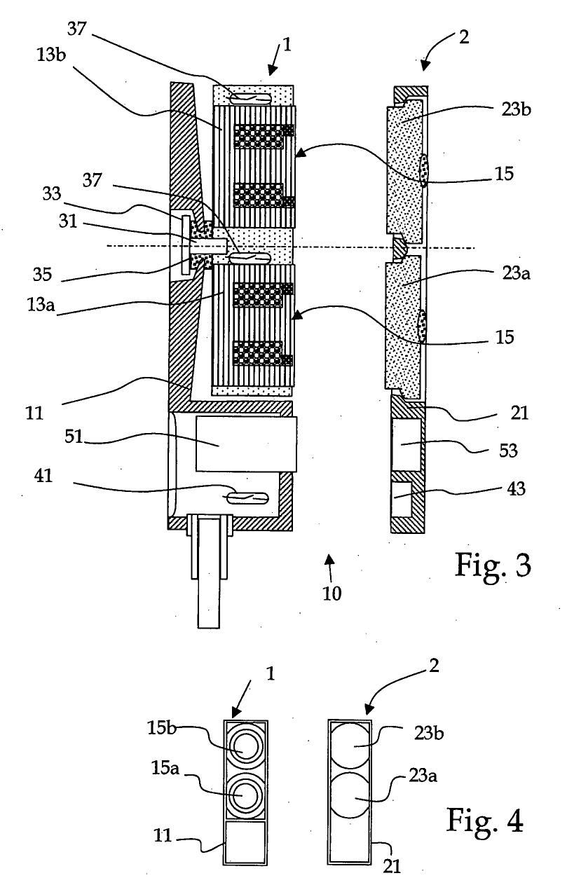

In FIGS. 3 and 4, a locking device according to the disclosure that has two electromagnets is shown. The first base plate 11 is provided with a hole, in which a pin 31 is located. The pin is anchored in a housing in which two electromagnets 13a and 13b are integrated. In this case, the central axis is a common working axis of both electromagnets. The second base plate 21 accordingly carries two yoke plates 23a, 23b, which are inserted individually into the base plate.

In FIG. 4, the views of the pole surfaces 15 and the yoke plates 23 of the first component 1 and the second component 2 are shown. It is thereby indicated that the winding spaces of the pot-shaped magnets are cylindrical, i.e., they have a circular ring-shaped cross-section. This form is most advantageous for winding. So that the device has a thin contour, however, the outside contours of the pot-shaped magnets 13 and the yoke plates 23 are trimmed laterally. The ring, which forms the peripheral pole, is made thinner on two sides that are opposite one another than on the remainder of its periphery. The electromagnets 13a, 13b are formed in a common, rectangular housing. The reed contacts 37, which are shown as lying in a middle section plane in FIGS. 1 to 3, can in each case be integrated into one corner of the housing, so that the overall size of the first component 1 is not too long. The two reed contacts for the two electromagnets can be located as much as possible at a distance to the respective other electromagnets to activate only the one electromagnet.

The housing with the electromagnets is fastened in a pivotable manner to the base plate 11.

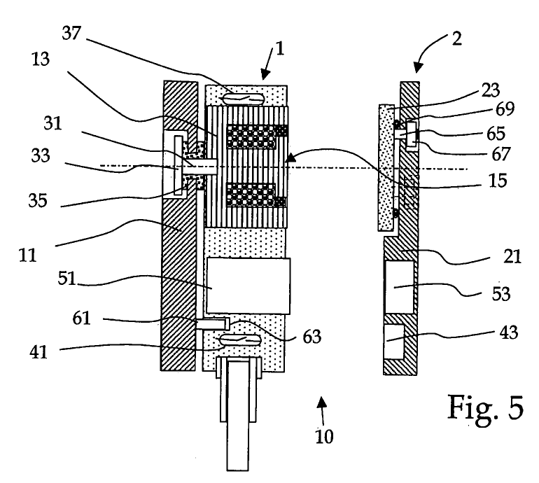

The alternative design of the locking device 10, shown in FIG. 5, has the following differences: Unlike the locking device according to FIG. 2, the reed contact 41 and the RFID element 51 are not integrated into the base plate 11, but rather in a housing that is mounted to pivot on the base plate 11, and the electromagnet 13 is also located in said housing. So that this housing cannot twist around the pin 31, a rotation-prevention device is provided. The latter comprises a pin 61 and a receiving part 63 for the pin 61. In the pictured example, the pin 61 is located on the base plate 11 and extends into the receiving part 63 that is made in the housing. The receiving part 63 could also be made, however, in the base plate 11, and the pin 61 could be made in the housing. As a variant thereto, a rotation-prevention device can also be made. It is to allow, however, a tipping of the housing around the fulcrum on the central axis through the electromagnet 13. To this end, a space is provided between the pin and the receiving part.

Also, the yoke plate is designed differently. The latter is fastened to the base plate with three threaded bolts 65 and nuts 67 screwed onto them. This embodiment is preferred, since the yoke plate can be adjusted. Because of an elastic intermediate layer 69 between the yoke plate and the base plate 21, the relative positions of these parts to one another can be adjusted by the three nuts 67. The elastic intermediate layer 69, a rubber ring, absorbs the shocks that occur, moreover, when the electromagnet hits the yoke plate.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Locking device with an electromagnet and a yoke plate that closes the magnetic circuit of the electromagnet, and said electromagnet is fastened with a central pin that is fastened to the electromagnet to pivot around a point on a central axis and is fastened tightly to a base in the longitudinal direction of the central axis, and said central axis runs perpendicular to the contact plane between the electromagnet and the yoke plate and through the center of the holding force of the closed electromagnet, wherein the pin is fastened in such a way that it cannot pivot to the electromagnet and in that the pin is mounted to pivot on the base.

2. Locking device according to claim 1, wherein the pin is run through a hole in the base, and wherein on the side of the base that faces away from the electromagnet, an elastic intermediate layer is present between a top formation on the pins and the base, and the diameter of the hole is larger than the diameter of the pin.

3. Locking device according to claim 1, wherein in the locking device, at least one monitoring element is present to monitor the closed state of the locking device.

4. Locking device according to claim 1, wherein an electromechanical or electronic element that reacts to a magnetic flux is present adjacent to the electromagnet or inside the electromagnet to monitor the closed state of the magnetic circuit.

5. Locking device according to claim 1, wherein a first base plate carries the electromagnets and is fastened in a pivotable manner and tightly to a base.

6. Locking device according to claim 1, wherein the electromagnet is fastened in a pivotable manner and tightly to the first base plate.

7. Locking device according to claim 1, wherein a first base plate and a second base plate are present, and wherein the first base plate carries the electromagnets and the second base plate carries the yoke plate.

8. Locking device according to claim 7, wherein the yoke plate is fastened in a pivotable manner and tightly to the second base plate.

9. Locking device according to claim 7, wherein the second base plate is fastened in a pivotable manner and tightly to a base.

10. Locking device according to claim 1, wherein the locking device has two components, of which a first component comprises the electromagnets and a second component comprises the yoke plate, and wherein the first or second component is equipped with a permanent magnet, and the other component is equipped with an electromechanical or electronic element that reacts to the magnetic field of the permanent magnet.

11. Locking device according to claim 10, wherein the first and the second components, in particular the first and second base plates, each have one of two electronic transmitting/receiving devices that work together in a non-contact manner.

12. Locking device according to claim 11, wherein the influence of the magnetic field of the permanent magne has the effect that the electromagnet is activated.

13. Locking device according to claim 11, wherein the interaction between the transmitting/receiving devices is used for detecting the distance between the two components or base plates.

14. Locking device according to claim 1, wherein a safety switch, with which it is monitored whether the signal of the transmitting/receiving device is present, and whether the signal of the electromechanical or electronic element that reacts to a magnetic flux and is adjacent to the electromagnet or within the electromagnet is present, is present.

15. Locking device according to claim 1, wherein the electromagnet is a pot-shaped magnet and has a central core, which forms a central pole, and a ring, which is connected to this central core at the bottom of the pot and forms a peripheral pole, and its winding is formed between the core and the ring, and in which the diameter of the central pole on its pole side is larger than the diameter of the core in the area of the winding.

16. Locking device with an electromagnet and a yoke plate that closes the magnetic circuit of the electromagnet, and in said locking device, the electromagnet is a pot-shaped magnet and has a central core, which forms a central pole, and it has a ring that is connected to this central core at the bottom of the pot and forms a peripheral pole, and its winding is formed between the core and the ring, wherein in the pot-shaped magnet, the diameter of the central pole on its pole side is larger than the diameter of the core in the area of the winding.

17. Locking device according to claim 2, wherein in the locking device, at least one monitoring element is present to monitor the closed state of the locking device.

18. Locking device according to claim 3, wherein an electromechanical or electronic element that reacts to a magnetic flux is present adjacent to the electromagnet or inside the electromagnet to monitor the closed state of the magnetic circuit.

19. Locking device according to claim 4, wherein a first base plate carries the electromagnets and is fastened in a pivotable manner and tightly to a base.

20. Locking device according to claim 5, wherein the electromagnet is fastened in a pivotable manner and tightly to the first base plate.

21. Locking device according to claim 6, wherein a first base plate and a second base plate are present, and wherein the first base plate carries the electromagnets and the second base plate carries the yoke plate.

22. Locking device according to claim 8, wherein the second base plate is fastened in a pivotable manner and tightly to a base.
